(19) United States
(12) Patent Application Publication
(10) Pub. No.: US 2006/0020945 A1
(43) Pub. Date: Jan. 26, 2006

(54) System, circuitry and method for parallel processing real-time signal with open structure

(76) Inventors: Che-Hui Chang Chien, Longtan Township (TW); Yu-Lin Su, Taipei Hsien (TW)

Correspondence Address: J.C. Patents, Inc., Suite 250, 4 Venture, Irvine, CA, 92618, US

(21) Appl. No.: 10/863,655

(22) Filed: Jun. 7, 2004

(51) Int. Cl. G06F 9/46

(52) U.S. Cl. 718/107

(57) ABSTRACT

A system for parallel processing real-time signal with open structure comprises a host computer, a circuitry for parallel processing real-time signal with open structure, a plurality of peripheral devices and an analog signal processing device. Wherein, the host computer controls the peripheral devices and the analog signal processing device through the circuitry of the present invention. The circuitry of the present invention processes a plurality of digital echo raw data generated by the analog signal processing device with parallel signal processing, and generates report information reporting to the host computer.

### BACKGROUND OF THE INVENTION

1. Field of the Invention

The present invention relates to a real-time signal processing circuitry, system, and method, and more particularly, to a circuitry, system, and method for parallel processing real-time signal with open structure.

2. Description of the Related Art

Thanks to the great progress of the semiconductor technology and the improvement and prevalence of the functions provided by the digital signal process (DSP) components recently, a parallel processing structure is commonly used in the real-time digital signal processing. The real-time digital signal processing is inevitable in military application, for example, the radar signal processing device is one of the most important devices in military application.

The technique of the conventional real-time signal processing is embodied with either hardware or software structure. However, both implementations have its disadvantage. Wherein, when the real-time signal is processed with the hardware structure, although the processing can be accelerated and the operations can be operated simultaneously, it is required to design different hardware circuitries for dealing with different system specification. If the real-time signal is processed with the software structure, although it provides more scalability than the hardware structure, it is hard to achieve the real-time processing requirement. In addition, the processor for the software structure is mostly an asynchronous system, it will be hard to synchronize it with the entire real-time signal processing system.

In real-time signal processing applications, embedded multicomputers are useful to realize the real-time requirement and capable to attain the programmable requirement. Parallel algorithms run on the embedded multiprocessor will be implemented in the present invention. In signal processings, correlation and convolution processes are usually operated with a huge data size. The execution time for these two processes will be decreasing by using multiple DSP processors with coprocessors in the present invention.

### SUMMARY OF THE INVENTION

In the light of the preface, it is an object of the present invention to provide a system for parallel processing real-time signal with open structure so as to achieve the entire system synchronization.

It is another object of the present invention to provide a circuitry for parallel processing real-time signal with open structure, and the circuitry provided by the present invention is expandable.

It is yet another object of the present invention to provide a method for parallel processing real-time signal with open structure so as to achieve the real-time processing requirement.

It is an object of the present invention to provide a system for parallel processing real-time signal with open structure. The system comprises a host interface unit, which is used to connect the real-time signal processing system of the present invention to the host computer via some computer network. Wherein, the host interface unit transforms the control commands from the host computer to the real-time signal processing system, and returns back the processing reports from the real-time signal processing system to the host computer. In addition, the real-time signal processing system of the present invention further comprises an interface control processor, an analog signal control processor, and a digital signal scheduling control processor. Wherein, the interface control processor, which is a module with any type of general purpose CPU or DSP chip processor, is coupled to the host interface unit and is used to control the peripheral devices according to the control commands generated by the host interface unit. The analog signal control processor, which is a module with any type of general purpose CPU or DSP chip processor, is coupled to the interface control processor and is used to control the external analog signal processing system according to the control commands provided by the interface control processor. In addition, the digital signal scheduling control processor is coupled to the interface control processor and used to provide a plurality of scheduling control commands according to the control commands provided by the interface control processor. Moreover, the present invention further comprises a digital signal process equipment, which is used to receive the digital echo raw data and to process the digital echo raw data according to the scheduling control commands.

Preferably, the present invention further comprises a self-test control processor, which is used to execute a self-test instruction, which is a module with any type of general purpose CPU or DSP chip processor, provided by the host interface unit and to generate and send a self-test result to the host interface unit.

In an embodiment of the present invention, the digital signal process equipment comprises a data inject module and an input data buffer module. Wherein, the data inject module is used to receive the digital echo raw data and to covert the digital echo raw data from differential type to TTL type. The input data buffer module is coupled to the data inject module for storing the digital echo raw data and provides pre-processing for the digital echo raw data. In addition, the digital signal process equipment further comprises a plurality of vector signal processors, which is a module with any type of multiple general purpose CPUs or DSP chip processors, which are coupled to the input data buffer module for parallel processing the digital echo raw data.

According to another aspect of the present invention, the present invention provides a circuitry for parallel processing real-time signal with open structure. The circuitry of the present invention comprises a local bus and a host interface module. Wherein, the host interface module is coupled to the local bus and used to generate and send control commands to the local bus according to a system synchronization signal and instructions from the host computer. In addition, the present invention further comprises an I/O buffer control module, an analog signal processing control module, and a digital signal scheduling control module. Wherein, the I/O buffer control module generates control commands for controlling the peripheral devices according to the control commands generated by the host interface module. The analog signal processing control module generates control commands for controlling an analog signal processing system according to the control commands provided by the I/O buffer control module. In addition, the digital signal scheduling control module generates and provides scheduling control commands to the local bus according to the control commands provided by the I/O buffer control module. Moreover, the present invention further comprises a digital signal process equipment including of a data inject module, an input data buffer module and a plurality of vector signal processors, which is coupled to the local bus, too. The digital signal process equipment receives the digital echo raw data and reads the scheduling control commands via the local bus, so as to process the received digital echo raw data.

According to another aspect of the present invention, the present invention provides a method for parallel processing real-time signal with open structure, and the method is suitable for applying on a real-time parallel signal processing system having a host computer. The method for parallel processing real-time signal provided by the present invention comprises following steps. At first, a system synchronization signal is generated and an I/O buffer main program is executed according to the system synchronization signal and the instructions from the host computer. Wherein, the I/O buffer main program provides a plurality of system control instructions generated by the host computer to the function of the analog signal processing and the function of the digital signal processing. Then, an analog signal processing main program and a digital signal processing main program are executed according to the system synchronization signals. Finally, a vector signal processing main program is executed to process the digital echo raw data, and a record of report result is generated and provided to the host computer according to the control commands provided by the digital signal processing main program.

In summary, the present invention provides a plurality of vector signal processors, which are used to process a plurality of records of real-time signal in parallel, such that the entire system synchronization is achieved. In addition, the digital signal scheduling control processor can adjust the order of processing signals according to the returned digital echo raw data, such that the real-time requirement can be met. Moreover, since the present invention can adjust the quantity of modules based on the real requirements, the present invention is also highly expandable.

### BRIEF DESCRIPTION OF THE DRAWINGS

The accompanying drawings are included to provide a further understanding of the invention, and are incorporated in and constitute a part of this specification. The drawings illustrate embodiments of the invention, and together with the description, serve to explain the principles of the invention.

FIG. 1A is a functional block diagram illustrating a system for parallel processing real-time signal with open structure according to a preferred embodiment of the present invention.

FIG. 1B is a functional block diagram illustrating a system for parallel processing real-time signal with open structure according to another embodiment of the present invention.

FIG. 2 is a detail internal hardware structure block diagram illustrating a real-time signal processing circuitry of FIG. 1B.

FIG. 3 is a flow chart illustrating a method for parallel processing real-time signal with open structure according to a preferred embodiment of the present invention.

FIGS. 4A and 4B are flow charts illustrating an I/O buffer main program according to a preferred embodiment of the present invention.

FIGS. 5A and 5B are flow charts illustrating an analog signal processing main program according to a preferred embodiment of the present invention.

FIGS. 6A and 6B are flow charts illustrating a digital signal processing main program according to a preferred embodiment of the present invention.

FIG. 7 is a flow chart illustrating a vector signal processing main program according to a preferred embodiment of the present invention.

### DESCRIPTION OF THE PREFERRED EMBODIMENTS

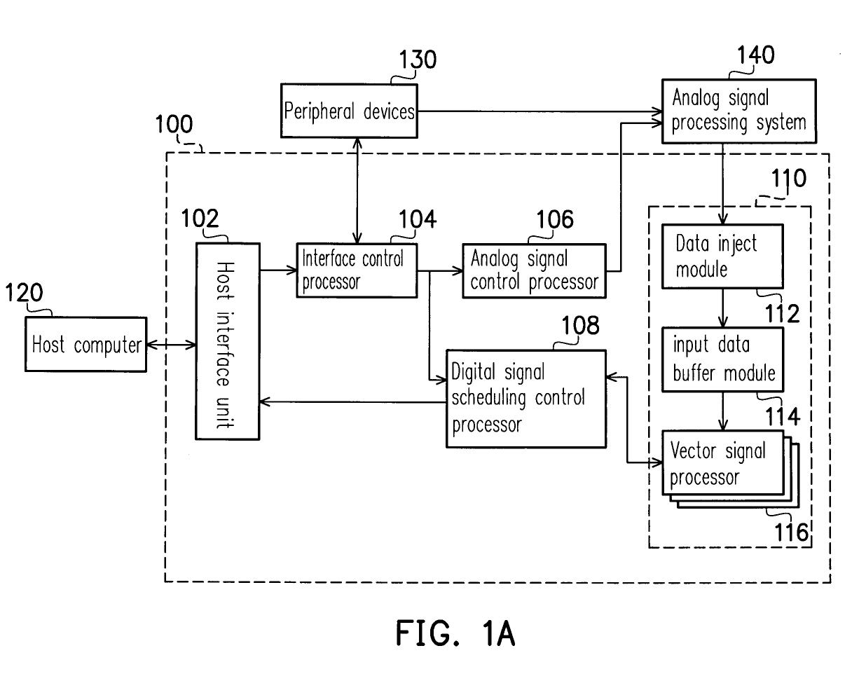

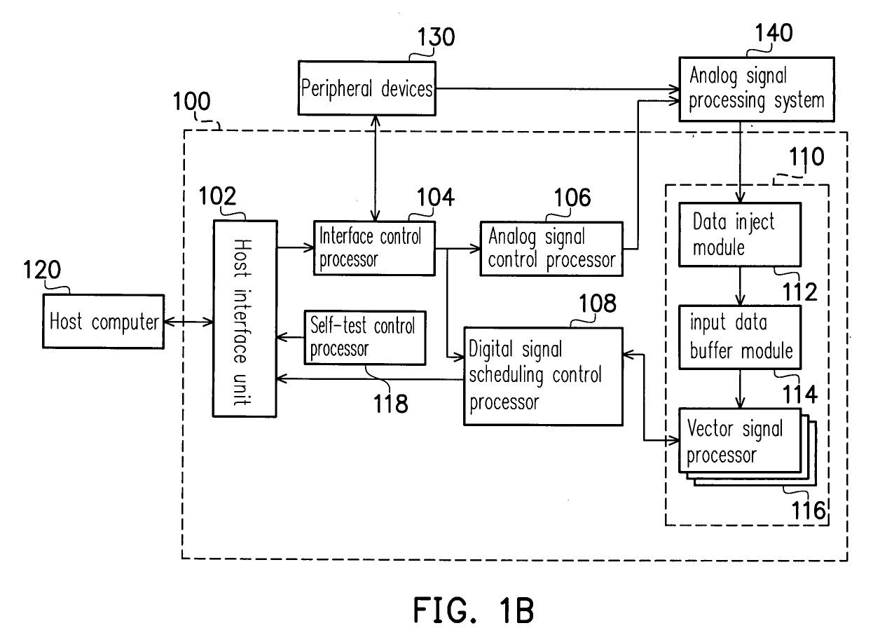

FIG. 1A is a functional block diagram illustrating a system for parallel processing real-time signal with open structure according to a preferred embodiment of the present invention. Referring to FIG. 1A, a real-time parallel signal processing circuitry 100 with open structure is provided by the present invention. Wherein, a host interface unit 102 is coupled to a host computer 120 via a computer network, e.g. Ethernet, and its output is propagated to an interface control processor 104, which is a module with any type of general purpose CPU or DSP chip processor. The interface control processor 104 controls several peripheral devices 130 of the real-time signal processing circuitry 100, and its output is coupled to an analog signal control processor 106, which is a module with any type of general purpose CPU or DSP chip processor, and a digital signal scheduling control processor, respectively. Wherein, the analog signal control processor 106 controls an analog signal processing system 140, for example, a radar, a sonar, a medical ultrasound, or a wireless communication system. The present invention further comprises a digital signal process equipment 110, which is used to receive the digital echo raw data returned by the analog signal processing system 140 and to process the digital echo raw data according to the control commands provided by the digital signal scheduling processor 108.

Referring to FIG. 1A again, the digital signal process equipment 110 comprises a data inject module 112, which is used to receive the digital echo raw data returned by the analog signal processing system 140, for example, a real-time returned radar echo signal of the radar system. Then, after the digital echo raw data passes through the data inject module 112, the digital echo raw data is stored into an input data buffer module 114, then vector signal processors 116, which is a module with any type of multiple general purpose CPUs or DSP chip processors, reads the digital echo raw data from the input data buffer module 114, and performs parallel signal processing on it. The parallel signal processing operation of the vector signal processors 116 is implemented by software. In addition, in the present invention, the quantity of the interface control processor 104 and the vector signal processor 116 are adjustable and depends on the real requirements, such that it can control a plurality of peripheral devices 130 and process a plurality of records of digital echo raw data simultaneously.

FIG. 1B is a functional block diagram illustrating a system for parallel processing real-time signal with open structure according to another embodiment of the present invention. Referring to FIG. 1B, in an alternative embodiment of the present invention, the real-time signal processing circuitry 100 of the present invention further comprises a self-test control processor 118. The self-test control processor 118 executes a self-test instruction, which is a module with any type of general purpose CPU or DSP chip processor, generated by the host interface unit 102 and generates and provides a self-test result to the host computer 120 via the host interface unit 102.

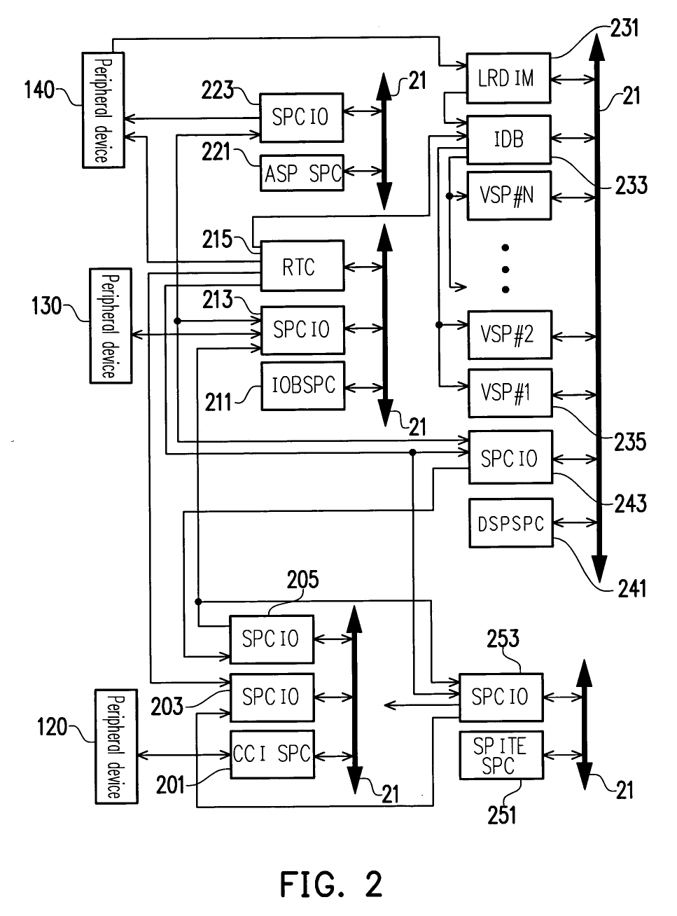

FIG. 2 is a detail internal hardware structure block diagram illustrating a real-time signal processing circuitry of FIG. 1B. Referring to FIG. 2, a host interface module 201 and interface modules 203, and 205 which constitute the host interface unit 102, are all jointly coupled to a local bus 21. In the present embodiment, the local bus is, for example, a VME bus or a CPCI (Compact Peripheral Component Interconnection) bus. Wherein, the host interface module 201 receives system control instructions and a self-test instruction generated by the host computer 120 at every system operating cycle. After receiving a system synchronization signal and instructions from the host computer 120, the host interface module 201 propagates the system control instructions to an interface module 213 via the interface module 205, and propagates the self-test instruction to an interface module 253 via the interface module 205.

An I/O buffer control module 211, an interface module 213, and a real-time timing control module 215, which constitute the interface control processor 104, are all jointly coupled to the local bus 21. After receiving a system synchronization signal, the I/O buffer control module 211 receives the system control instructions from the interface module 213 and generates control commands for controlling the peripheral devices 130, an analog signal processing system 140 and the digital signal process equipment 110, then the control commands are provided to the interface modules 223 and 243. In addition, a self-test module 251 and the interface module 253, which constitute the self-test control processor 118, are both jointly coupled to the local bus 21. After receiving the system synchronization signal, the self-test module 251 receives and executes the self-test instruction received from the interface module 253. After the executing of the self-test instruction is completed by the self-test module 251, a self-test result is generated and returned to the host interface module 201 via the interface module 253.

An analog signal processing control module 221 and the interface module 223, which constitute the analog signal control processor 106, are both jointly coupled to the local bus 21. After receiving the system synchronization signal, the analog signal processing control module 221 receives the control commands from the interface module 223 and configures the analog signal processing system 140 according to the control commands. In addition, a digital signal processing control module 241 and the interface module 243, which constitute the digital signal scheduling control processor 108, are both jointly coupled to the local bus 21. After receiving the control commands provided by the I/O buffer control module 211 from the interface module 243, the digital signal processing control module 241 generates a plurality of scheduling control commands and configures a data input buffer module 233 and a plurality of vector signal processors 235.

A data inject module 231, the data input buffer module 233, and the plurality of vector signal processors 235, which constitute the digital signal process equipment 110, are all jointly coupled to the local bus 21. After the data input buffer module 233 receives an activation signal, the data inject module 231 receives the digital echo raw data from the analog signal processing system 140. Then, the data input buffer module 233 performs a pre-process on the digital echo raw data, wherein the pre-process includes the processes of varied frequency sampling, coefficient processing by the digital filter, and other noise elimination processes, etc. Then, the digital echo raw data is provided to the vector signal processors 235, in which a plurality of parallel signal processing operations are performed on the plurality of records of the digital echo raw data, respectively. After the digital echo raw data has been processed respectively, a report information is generated and provided to the local bus 21. Meanwhile, the vector signal processing modules 235 notify the digital signal processing control module 241, and then the digital signal processing control module 241 provides the report information to the host interface module 201 via the interface module 243, and finally the host interface module 201 provides the report information to the host computer 120.

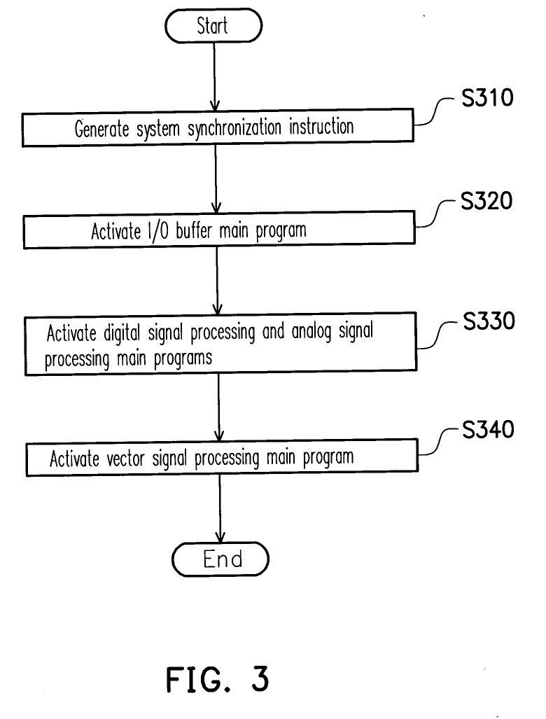

FIG. 3 is a flow chart illustrating a method for parallel processing real-time signal with open structure according to a preferred embodiment of the present invention. Referring to FIG. 3, the real-time signal processing method disclosed in the present embodiment may be applied on a real-time parallel signal processing system having a host computer, for example, the hardware structure mentioned above. At first, a system synchronization instruction is generated after system power up in step S310. Then, an I/O buffer main program is activated in step S320, and both the digital signal processing main program and the analog signal processing main program are activated in step S330. Finally, a vector signal processing main program is activated in step S340.

In an alternative embodiment, at the moment when the I/O buffer main program is being activated, the real-time parallel signal processing system of the present invention is also performing a self-test operation and generating a self-test result which is then provided to the host computer.

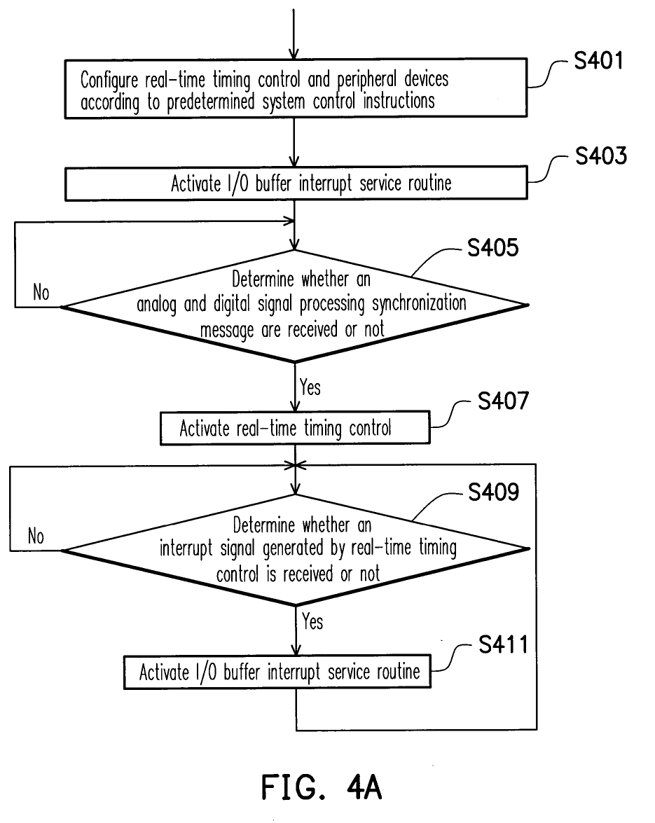

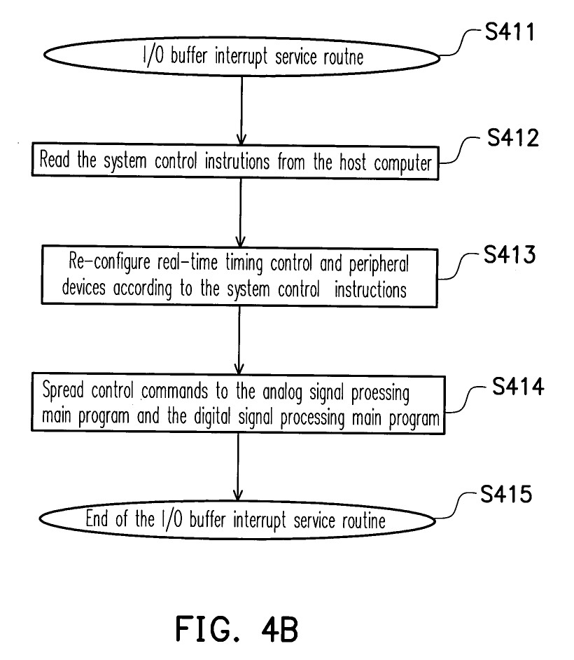

FIGS. 4A and 4B are flow charts illustrating an I/O buffer main program according to a preferred embodiment of the present invention. Referring to FIGS. 4A and 4B, at first, the real-time timing control and the peripheral devices are configured according to a predetermined system control instructions in step S401. Then, an I/O buffer interrupt service routine is activated in step S403, and it is determined whether an analog signal processing synchronization message and a digital signal processing synchronization message are received or not in step S405. If the I/O buffer main program receives the analog signal processing synchronization message and the digital signal processing synchronization message (i.e. the “Yes” branch of the step S405), the step S407 is performed, in which the real-time timing control is activated. Then, it is determined whether an interrupt signal generated by the real-time timing control is received or not in step S409. If the I/O buffer main program receives the interrupt signal generated by the real-time timing control (i.e. the “Yes” branch of the step S409), the step S411 is performed, in which the I/O buffer interrupt service routine is activated and then the step S407 and S409 are repeated infinitely.

In the present embodiment, the flow of the I/O buffer interrupt service routine in step S411 is as follows: first, reading the system control instructions generated by the host computer in step S412; then, reconfiguring the real-time timing control and the peripheral devices according to the system control instructions generated by the host computer in step S413; and providing the system control instructions generated by the host computer to the analog signal processing main program and the digital signal processing main program in step S414. Finally, end this interrupt service routine in step S415 and return to the I/O buffer main program.

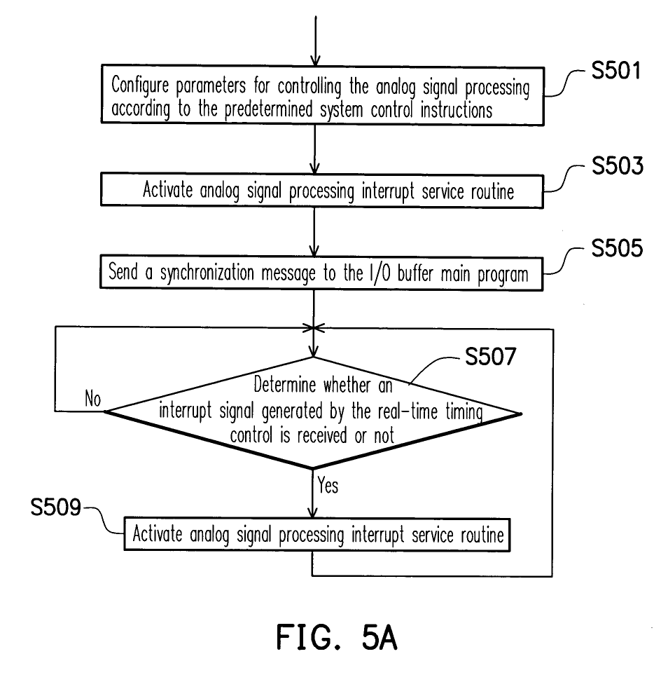

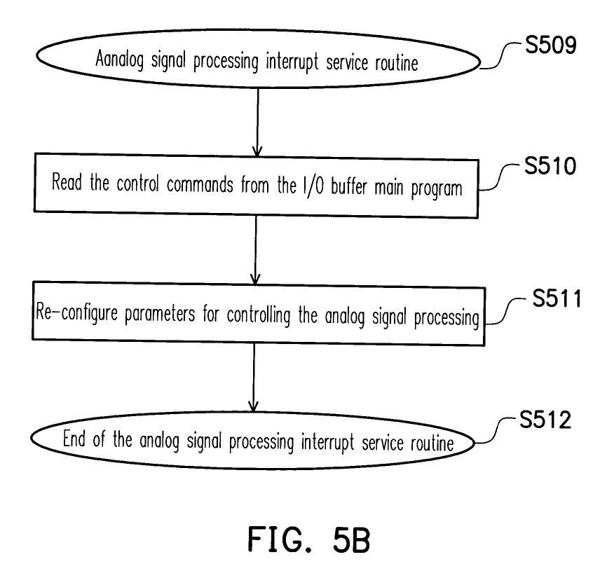

FIGS. 5A and 5B are flow charts illustrating an analog signal processing main program according to a preferred embodiment of the present invention. Referring to FIGS. 5A and 5B, the analog signal processing main program is mainly used to configure a plurality of parameter values for processing the analog system control signals. At first, the parameters for controlling the analog signal processing are configured according to the predetermined system control instructions in step S501. Then, an analog signal processing interrupt service routine is activated in step S503, and a synchronization message is generated and sent to the I/O buffer main program in step S505. Then, it is determined whether an interrupt signal generated by the real-time timing control is received or not in step S507. If the analog signal processing main program receives the interrupt signal generated by the real-time timing control (i.e. the “Yes” branch of the step S507), the step S509 is performed, in which the analog signal processing interrupt service routine is activated and then the step S507 is repeated infinitely.

The analog signal processing interrupt service routine mentioned above is mainly used to configure all signals required by the hardware for processing the analog signal, and to configure timing required for synchronizing the analog signal processing with the system. In the present embodiment, the flow of the analog signal processing interrupt service routine in step S509 is as follows: at first, reading the system control commands generated by the I/O buffer main program in step S510; and then configuring the parameters for controlling the analog signal processing according to the system control commands generated by the I/O buffer main program in step S511. Finally, end this interrupt service routine in step S512 and return to the analog signal processing main program.

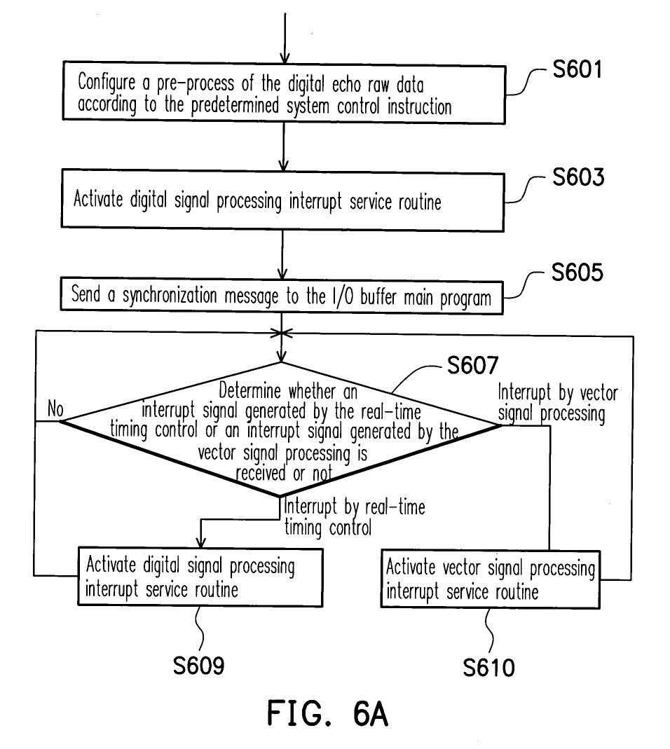

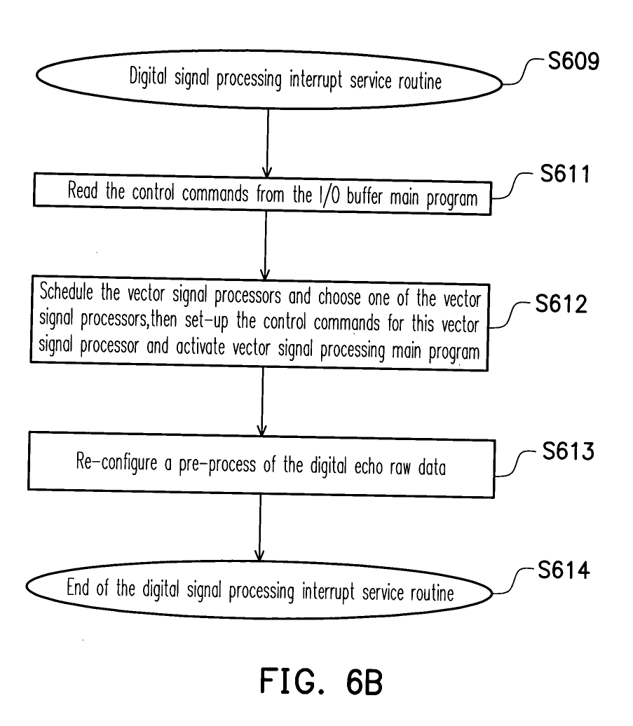

FIGS. 6A and 6B are flow charts illustrating a digital signal processing main program according to a preferred embodiment of the present invention. Referring to FIGS. 6A and 6B, the digital signal processing main program is mainly used to configure an initial value required by the hardware for processing the digital signals, and its flow is described hereinafter. At first, a pre-process of the digital echo raw data is configured according to the predetermined system control instructions in step S601. Then, the digital signal processing interrupt service routine and the vector signal processing interrupt service routine are both activated in step S603, and a digital signal processing synchronization message is generated and sent to the I/O buffer main program in step S605. Meanwhile, it is determined whether an interrupt signal generated by the real-time timing control or an interrupt signal generated by the vector signal processing is received or not in step S607. If the interrupt signal generated by the real-time timing control is received, the step S609 is performed, in which the digital signal processing interrupt service routine is activated and then the step S607 is repeated infinitely. If the interrupt signal generated by the vector signal processing is received, the step S611 is performed, in which the vector signal processing interrupt service routine is activated and then the step S607 is repeated infinitely.

In the present embodiment, the flow of the digital signal processing interrupt service routine in step S609 is as flows: at first, reading control commands generated by the I/O buffer main program in step S611; and then scheduling and choosing suitable vector signal processors, and activating the vector signal processing according to the control commands generated by the I/O buffer main program in step S612, and also reconfiguring a pre-process of the digital echo raw data in step S613. Finally, end this interrupt service routine in step S614 and return to the digital signal processing main program. The flow of the vector signal processing interrupt service routine comprises reading and recording interrupt information generated by the vector signal processing.

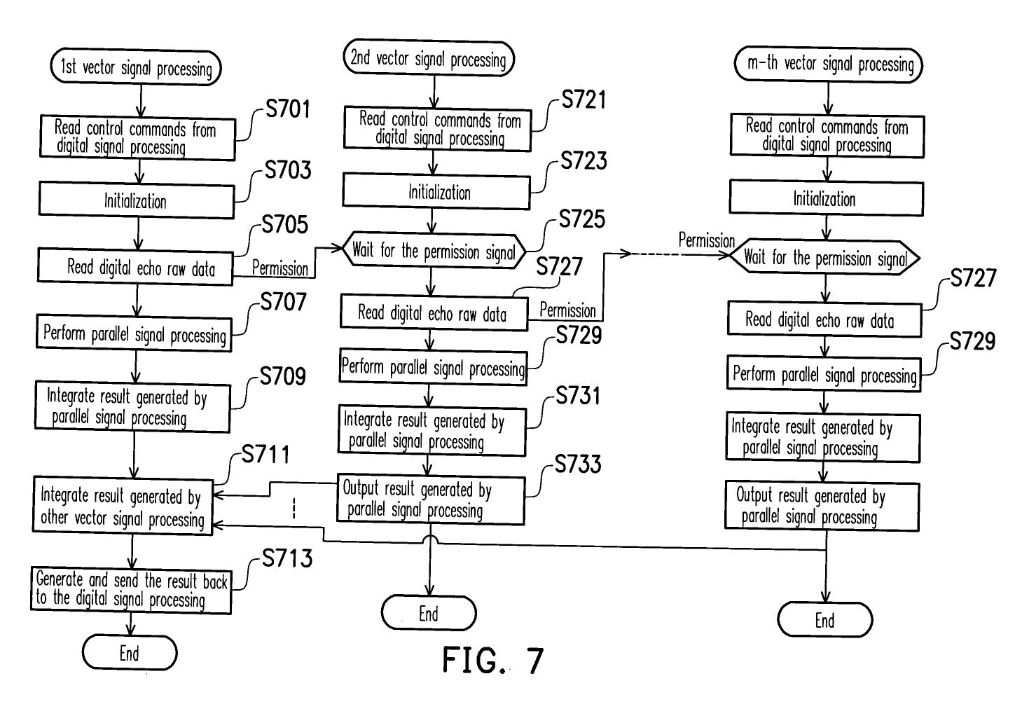

FIG. 7 is a flow chart illustrating a vector signal processing main program according to a preferred embodiment of the present invention. Referring to FIG. 7, the vector signal processing main program comprises a quantity of n vector signal processings (n is a positive integer), which is activated according to the digital signal processing main program, respectively. In the present embodiment, the vector signal processing main program comprises two major parts, wherein the first part is executing the 1^{st} vector signal processing, and the second part is executing the 2^{nd} to the n^{th} vector signal processing.

When the vector signal processing main program is executing the 1^{st} vector signal processing, instructions from the digital signal processing main program are read in step S701 and then the initialization is performed in step S703. When the digital echo raw data is provided, the digital echo raw data is read in step S705, and a permission signal is generated and provided to the 2^{nd} vector signal processing after the reading of the digital echo raw data is completed. Then, the parallel signal processing is performed on the digital echo raw data in step S707. After the digital echo rawreport data has processed, the result generated by the parallel signal processing is integrated in step S709, and the result generated by other parallel signal processing is integrated in step S711. Finally, a report result is generated and returned to the digital signal processing main program in step S713.

When the vector signal processing main program is executing the m^{th} vector signal processing (m is a positive integer greater than 1 and less than n), similarly, instructions generated by the digital signal processing main program are read in step S721 and then the initialization operation is performed in step S723. Then, it is waiting for a permission signal generated by the previous vector signal processing in step S725. After lo receiving the permission signal generated by the previous vector signal processing, the digital echo raw data is read in step S727, and thereafter a permission signal is generated and provided to the next vector signal processing. After the reading of the digital echo raw data is completed, a parallel signal processing is performed in step S729, and the result generated by the m^{th} parallel signal processing is integrated in step S731. Finally in step S733, an integrated result is provided to the 1^{st} vector signal processing for performing step S711.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

What is claimed is:

1. A system for parallel processing a real-time signal with an open structure, comprising:
a host interface unit for connecting the real-time signal processing system and a host computer through a computer network, wherein the host interface unit generates a plurality of control commands according to the host computer;
an interface control processor, which is a module with any type of general purpose CPU or DSP chip processor, coupled to the host interface unit for controlling a plurality of peripheral devices according to the control commands provided by the host interface unit;
an analog signal control processor, which is a module with any type of general purpose CPU or DSP chip processor, coupled to the interface control processor for controlling an analog signal processing system according to the control commands provided by the interface control processor;
a digital signal scheduling control processor, which is a module with any type of general purpose CPU or DSP chip processor, coupled to the interface control processor for providing a plurality of scheduling control commands according to the control commands provided by the interface control processor; and
a digital signal process equipment for receiving a digital echo raw data and processing the digital echo raw data according to the scheduling control commands provided by the digital signal scheduling control processor.

2. The system for parallel processing the real-time signal with the open structure of claim 1, further comprising a self-test control processor for executing a self-test instruction, which is a module with any type of general purpose CPU or DSP chip processor, provided by the host interface unit and generating and providing a self-test result to the host interface unit.

3. The system for parallel processing the real-time signal with the open structure of claim 1, wherein the digital signal process equipment comprises:
a data inject module for receiving the digital echo raw data and converting the digital echo raw data from a differential type to a TTL type;
an input data buffer module coupled to the data inject module for storing the digital echo raw data and performing a pre-process on the digital echo raw data; and
a plurality of vector signal processors, which is a module with any type of multiple general purpose CPUs or DSP chip processors, coupled to the input data buffer module for parallel processing the digital echo raw data.

4. The system for parallel processing the real-time signal with the open structure of claim 3, wherein the functions of parallel processing the digital echo raw data is implemented on the vector signal processors by software.

5. The system for parallel processing the real-time signal with the open structure of claim 1, wherein the computer network comprises one of an Ethernet and a fast Ethernet.

6. A circuitry for parallel processing a real-time signal with an open structure, comprising:
a local bus;
a host interface module coupled to the local bus for generating and providing a plurality of control commands to the local bus according to a system synchronization signal;
an I/O buffer control module coupled to the local bus for generating the control commands for controlling a plurality of peripheral devices according to the control commands provided by the host interface module;
an analog signal processing control module for generating the control commands for controlling an analog signal processing system according to the control commands provided by the I/O buffer control module;
a digital signal processing control module coupled to the local bus for generating and providing the scheduling control commands for controlling a digital signal process equipment to the local bus according to the control commands provided by the I/O buffer control module; and
a digital signal process equipment for receiving a digital echo raw data and processing the digital echo raw data by reading the control commands provided by the digital signal processing control module via the local bus.

7. The circuitry for parallel processing the real-time signal with the open structure of claim 6, further comprising a self-test module for executing a self-test instruction provided by the host interface module via the local bus and generating and providing a self-test result to the host interface module via the local bus.

8. The circuitry for parallel processing the real-time signal with the open structure of claim 7, wherein the host interface module reads the self-test result from the local bus.

9. The circuitry for parallel processing the real-time signal with the open structure of claim 6, wherein the digital signal process equipment comprises:
a data inject module coupled to the local bus for receiving the digital echo raw data and converting the digital echo raw data from a differential type to a TTL type;
an input data buffer module coupled to the local bus for performing a pre-process on the digital echo raw data according to the control commands provided by the digital signal processing control module; and
a plurality of vector signal processors coupled to the local bus for parallel processing the digital echo raw data provided by the input data buffer module.

10. The circuitry for parallel processing the real-time signal with the open structure of claim 9, wherein the data inject module further comprises a flash memory for storing the digital echo raw data.

11. The circuitry for parallel processing the real-time signal with the open structure of claim 6, further comprising a real-time timing control module for providing a plurality of timing control signals to control the synchronization of overall system, the peripheral devices, the circuitry, and an analog signal processing system to generate the digital echo raw data.

12. The circuitry for parallel processing the real-time signal with the open structure of claim 6, further comprising a plurality of interface modules coupled to the local bus for using as an I/O interface between the real-time signal processing circuitry and outside and among the modules.

13. The circuitry for parallel processing the real-time signal with the open structure of claim 6, wherein the local bus comprises either a VME bus or a CPCI (Compact Peripheral Component Interconnection) bus.

14. A method for parallel processing a real-time signal with an open structure suitable for a real-time parallel signal processing system having a host computer, and the real-time signal processing method comprising:
generating a system synchronization signal;
executing an I/O buffer main program for providing a plurality of control commands generated by the host computer to a function of an analog signal processing and a function of a digital signal processing according to the system synchronization signal and instructions from the host computer;
executing an analog signal processing main program and a digital signal processing main program according to the system synchronization signal and the control commands provided by the I/O buffer main program; and
executing a vector signal processing main program for performing a parallel signal processing on a digital echo raw data and generating and providing a report result to the host computer according to the control commands provided by the digital signal processing main program.

15. The method for parallel processing the real-time signal with the open structure of claim 14, wherein at a moment of activating the I/O buffer main program, further comprises the real-time parallel signal processing system performing a self-test operation and generating and providing a self-test result to the real-time parallel signal processing system.

16. The method for parallel processing the real-time signal with the open structure of claim 14, wherein the step of executing the I/O buffer main program comprises:
configuring a real-time timing control and the peripheral devices of the real-time parallel signal processing system according to a plurality of predetermined system control instructions;
activating an I/O buffer interrupt service routine;
determining whether a synchronization message generated by one of the function of the analog signal processing main program and the function of the digital signal processing main program are received;
activating the real-time timing control;
determining whether an interrupt signal generated by the real-time timing control is received or not; and
activating the I/O buffer interrupt service routine when the interrupt signal generated by the real-time timing control is received.

17. The method for parallel processing the real-time signal with the open structure of claim 16, wherein the step of executing the I/O buffer interrupt service routine comprises:
reading the system control commands generated by the host computer;
reconfiguring the real-time timing control and the peripheral devices of the real-time parallel signal processing system according to the system control commands generated by the host computer; and
providing the system control commands generated by the host computer to the function of the analog signal processing and the function of the digital signal processing.

18. The method for parallel processing the real-time signal with the open structure of claim 14, wherein the step of executing the analog signal processing main program comprises:
configuring a plurality of parameters for controlling the analog signal processing according to a predetermined system control instructions;
activating an analog signal processing interrupt service routine;
generating a synchronization message to the I/O buffer main program;
determining whether an interrupt signal generated by the real-time timing control is received or not; and
activating the analog signal processing interrupt service routine when the interrupt signal generated by the real-time timing control is received.

19. The method for parallel processing the real-time signal with the open structure of claim 18, wherein the step of executing the analog signal processing interrupt service routine comprises:
reading the control commands generated by the I/O buffer main program; and
configuring the parameters for controlling the function of the analog signal processing according to the control commands generated by the I/O buffer main program.

20. The method for parallel processing the real-time signal with the open structure of claim 14, wherein the step of executing the digital signal processing main program comprises:
configuring a pre-process of the digital echo raw data according to a predetermined system control instructions;
activating a digital signal processing interrupt service routine and a vector signal processing interrupt service routine;
generating the synchronization message to the I/O buffer main program;
determining whether either an interrupt signal generated by the real-time timing control or an interrupt generated by the function of the vector signal processing is received or not;
activating the digital signal processing interrupt service routine when the interrupt signal generated by the real-time timing control is received; and
activating the vector signal processing interrupt service routine when the interrupt signal generated by the function of the vector signal processing is received.

21. The method for parallel processing the real-time signal with the open structure of claim 20, wherein the step of executing the digital signal processing interrupt service routine comprises:
reading the control commands generated by the I/O buffer main program;
configuring and activating the function of the vector signal processing according to the control commands generated by the I/O buffer main program; and
reconfiguring the pre-process of the digital echo raw data.

22. The method for parallel processing the real-time signal with the open structure of claim 21, wherein the step of executing the vector signal processing interrupt service routine comprises:
reading and recording an interrupt information provided by the vector signal processing; and
sending the interrupt information to the host computer.

23. The method for parallel processing the real-time signal with the open structure of claim 16, wherein the vector signal processing main program is activated according to the digital signal processing main program, and the vector signal processing main program comprises activating a quantity of n vector signal processings, n is a positive integer, and wherein a step of executing the 1^{st} vector signal processing comprises:
reading the control commands provided by the function of the digital signal processing;
performing an initialization;
reading the digital echo raw data and generating a permission signal to the 2^{nd} vector signal processing;
performing the 1^{st} parallel signal processing;
integrating a result generated by the 1^{st} parallel signal processing;
integrating a result generated by other parallel signal processing; and
generating and providing a result to the digital signal processing main program.

24. The method for parallel processing the real-time signal with the open structure of claim 23, wherein the step of executing the m^{th} vector signal processing (where m is defined as a positive integer greater than 1 and less than n) comprises:
reading the activation control commands provided by the digital signal processing main program;
performing an initialization;
waiting for the permission signal generated by the previous vector signal processing;
reading the digital echo raw data when the previous vector signal processing has sent out the permission signal and then providing the permission signal to the next vector signal processing;
performing the m^{th} parallel signal processing;
integrating a result generated by the m^{th} parallel signal processing; and
providing the result generated by the m^{th} parallel signal processing to 1^{st} vector signal processing for integration.
